(19) United States
(12) Patent Application Publication
(10) Pub. No.: US 2014/0109399 A1
(43) Pub. Date: Apr. 24, 2014

(54) DEVICE FOR MOUNTING A PEDAL IN AN AUTOMOBILE

(71) Applicants: Fabrice Merlin, Vert Le Grand, (FR); Rene-Paul Machon, MOrsang Sur Orge (FR); Jean Luc Malcuy, Sartrouville (FR)

(72) Inventors: Fabrice Merlin, Vert Le Grand, (FR); Rene-Paul Machon, MOrsang Sur Orge (FR); Jean Luc Malcuy, Sartrouville (FR)

(73) Assignee: RENAULT s.a.s., Boulogne Billancourt (FR)

(21) Appl. No.: 14/114,144

(22) PCT Filed: Feb. 13, 2012
(86) PCT No.: PCT/EP2012/052372

§ 371 Date: Dec. 20, 2013

(30) Foreign Application Priority Data
Apr. 26, 2011 (FR) 1153570

(51) Int. Cl. B60K 26/04

(52) U.S. Cl. CPC B60K 26/04
USPC 29/700

(57) ABSTRACT

A device for mounting a pedal in a vehicle, including a mounting on which the pedal is mounted via a rotational axle, a shearing mechanism connected to a stationary bodywork element of the vehicle, and capable of radially shearing the axle in event of a movement of the mounting relative to the bodywork element to disconnect the pedal from the mounting. A receiving mechanism is arranged near the axle of the pedal in the normal position thereof, and which is capable of receiving the axle after the axle is sheared such that the pedal can assume a second position adjacent to the normal position, wherein the second position enables the pedal to always be actuated to at least partially ensure the initial function thereof.

The invention relates to a device for mounting an actuating pedal on a vehicle. In general, a conventional motor vehicle is fitted with various actuating pedals, such as, for example, a brake pedal or a clutch pedal, which are situated near the driver's feet and emerge into an empty space positioned in front of the driver's seat. Aside from the fact of rigorously and precisely performing their function, these pedals need to be mounted in the vehicle in accordance with certain safety rules, particularly regarding driver safety. The invention relates more especially to a device for mounting an actuating pedal that takes driver safety into consideration, particularly in the event of a frontal impact.

Devices for mounting an actuating pedal in a motor vehicle already exist and have been patented. Mention may, for example, be made of Patent EP 0965506 which relates to a pedal mounting device, the principle of which is to use a shearing device the purpose of which is to detach the pedal from its mount if the front unit partially intrudes into the passenger compartment following an impact. What actually happens is that the pedal is fixed to its mount via a pivot pin, and the shearing device is arranged in the vehicle to chop through the two ends of the pedal pivot pin when said mount intrudes into said passenger compartment under the effect of a collision. As a result of this, the accidental travel of the pedal, which is initially connected to the moving mount, is halted very early on, thus preventing it from rigidly striking the legs of the driver.

However, the significant, if not to say major, risk incurred with this kind of mounting device is that the shearing device may be initiated unwontedly, without apparent reason, when the vehicle is not subjected to any impact. The pedal then dissociates from its mount, and the driver can no longer, for example, brake his vehicle or disengage the clutch. Admittedly, the probability of such a situation arising is minimal, but it does nonetheless still exist. Now, the consequences of unwanted deficiency of the braking or clutch system under normal driving conditions can be dramatic because they can lead to irreparable physical injury, or even fatalities. It therefore becomes urgent and necessary to make existing pedal mounting devices safer in order to avoid these potentially hazardous situations. The methods for mounting a pedal on a motor vehicle according to the invention are designed to allow the pedal which has thus been detached from its mount, either in a routine situation or in an accident, to maintain at least part of its functional integrity. Thus, a driver surprised not to be able to actuate his brake pedal or his clutch pedal in the normal way will still be able to retrieve the situation by nonetheless actuating the deficient pedal, because this pedal is configured to remain active even when detached from its mount.

The invention relates to a device for mounting a vehicle pedal, comprising a mount on which the pedal is mounted via a pivot pin, shearing means connected to a fixed bodywork element of said vehicle, said shearing means being able to shear said pivot pin radially if said mount moves in relation to said bodywork element, so as to detach said pedal from said mount. The main feature of a mounting device according to the invention is that it comprises catching means positioned near to the pivot pin of the pedal in its normal position and intended to catch said pivot pin once it has been sheared so as to allow said pedal to occupy a second position close to the position it usually occupies, this second position still allowing it to be actuated so that it can at least partially perform its initial function. It is important to emphasize that an actuating pedal comprises a lever arm, one end of which ends in a pad that embodies the surface on which the driver presses with his foot, and the other end of which is secured to the pivot pin. Thus, when said pivot pin is sheared, it is the entire pedal that is freed from its mount. The lever arm, the pad and the pivot pin form a single and indissociable entity. Thus, when the shearing means have operated to chop through the pivot pin of the pedal in order to free it from its mount, said pedal moves over a short distance because said pivot pin is quickly caught by the catching means. The pedal therefore finds itself in a position close to the position that it normally occupies, and thus maintains the possibility of being actuated by simple foot pressure on the part of the driver. The pedal can therefore maintain all, or at least a significant part, of its actuating potential intact, in order with minimum effectiveness to operate the mechanism to which it is connected.

Advantageously, the pedal is a brake pedal and the vehicle is a motor vehicle. The mounting devices according to the invention were initially developed for brake pedals mounted on motor vehicles because unforeseen failure of the braking system under normal driving conditions can have very dramatic consequences for individuals, whereas clutch failure may seem less severe.

For preference, the catching means comprise guide means and at least one stop piece for stopping said pivot pin. Specifically, it is important that the travel of the pedal, once the pedal has been detached from its mount, be controlled right from the start so that the pedal cannot become lodged in random positions, in a space not designed for it and in which it could prove dangerous. Thus, the guide device proves early control over the direction in which said pedal will move. The stop piece sets the new position of said pedal, once it has become detached from its mount.

For preference, the guide means comprise two rails which are parallel and at a slight slope, each of the two rails ending in a curved end, said ends each constituting a stop piece for stopping the pivot pin. This is a simple, quick to implement and widely proven approach. Advantageously, the two rails are perpendicular to the pivot pin of the pedal, said pivot pin sliding along said rails until it comes to a stop against each stop piece.

Advantageously, each end forms an elbow rounded at 180°, the radius of curvature of said elbow being greater than the radius of curvature of the pivot pin. Thus, each curved end can hug the pivot pin closely, preventing it from moving away from said rails and thus reducing the possibilities of said pivot pin “leaving” said rails.

Advantageously, the separation of the rails is great enough to allow the pedal to rotate once the pivot pin is resting against each of the stop pieces that stop it. This feature is important inasmuch as the pedal needs to maintain a degree of freedom to rotate so that it can still be actuated by pressure exerted by the driver's foot on the pad. The rails must never hamper the rotational pedal-actuation movement.

For preference, the shearing means comprise at least one cutter. In other words, the shearing means comprise at least one sharpened blade able to shear or chop through said pivot pin. For this embodiment, the pedal pivot pin is made rather of a material of the plastic type. Advantageously, the mounting device comprises two cutters, each one being positioned at one of the ends of the pivot pin.

Advantageously, each cutter comprises two cutting branches in the form of a V. This is an optimized configuration that ensures that the pivot pin is chopped through in the event of a frontal impact. What happens is that the pedal mount, to which said pivot pin is secured, is pushed back sharply in the event of a frontal impact, thus driving the pivot pin between the two branches of the cutter, where it is immediately sheared. A V-shaped configuration increases the cutting elements of the shearing device, the shearing action increasing gradually as the pivot pin progresses between the two branches.

For preference, the catching means are placed below the pivot pin of the pedal in normal operation, allowing said pivot pin to become lodged through inertia in said catching means once the pedal has been detached from its mount. Specifically, once the pivot pin has been chopped through and the pedal has become detached from its mount, this pedal has a natural tendency to start to fall toward the floor of the vehicle under the effect of its self weight. Thus, the catching means need to be positioned in such a way that can catch the pivot pin of said pedal as soon as possible. The catching means may thus be positioned either strictly in line with the pedal pivot pin or offset therefrom, the essential feature being that the pivot pin cannot evade the catching means.

For preference, the new position adopted by the pedal after it has been detached from its mount allows said pedal still to be actuated, but with a reduced travel. In other words, if it is assumed that the end-of-travel position of the pedal is the same between the normal configuration and the modified configuration, the pedal comes close to this end-of-travel position when it has moved from its normal position into its modified position. Thus, the range of actuating movement of the pedal in its new position will be shorter by comparison with the range corresponding to its normal position.

The pedal mounting devices according to the invention have the advantage of increasing safety of the occupants of a vehicle by allowing the driver still to have a residual pedal operating travel once the pedal has been detached from its mount following an impact or under normal driving conditions. Despite this additional functionality, these devices have the advantage of maintaining constant bulk in comparison with existing devices. Finally, the simplicity of the pedal catching mechanism used in these devices makes them extremely safe and highly reliable.

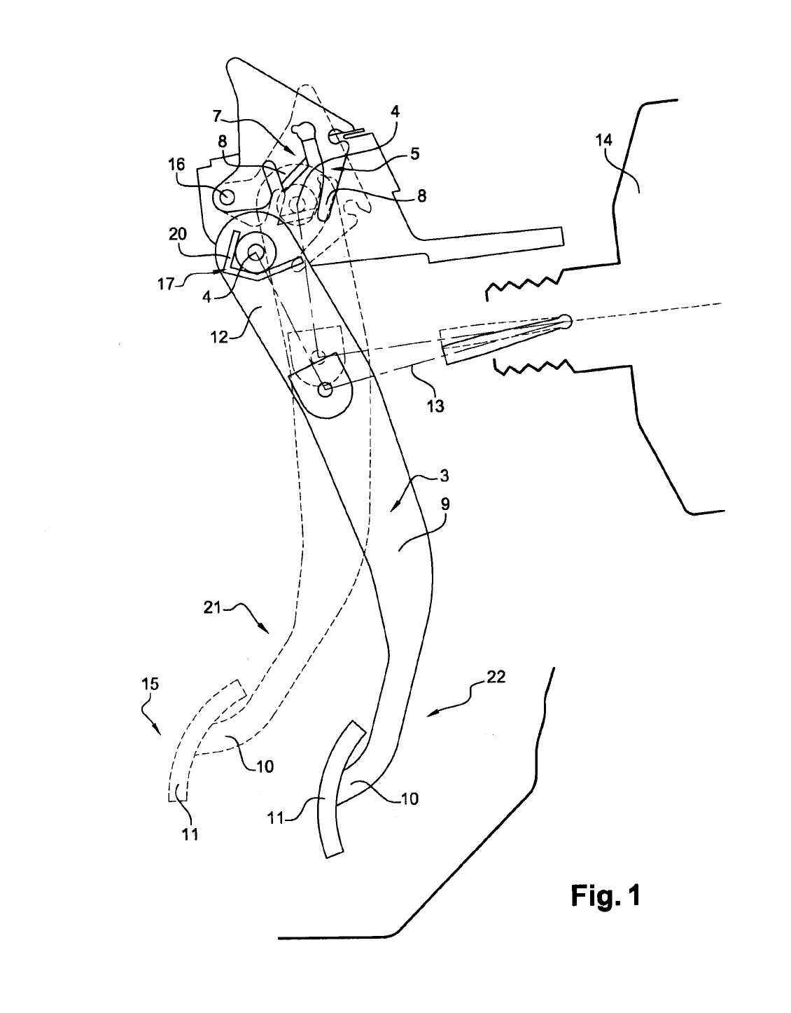

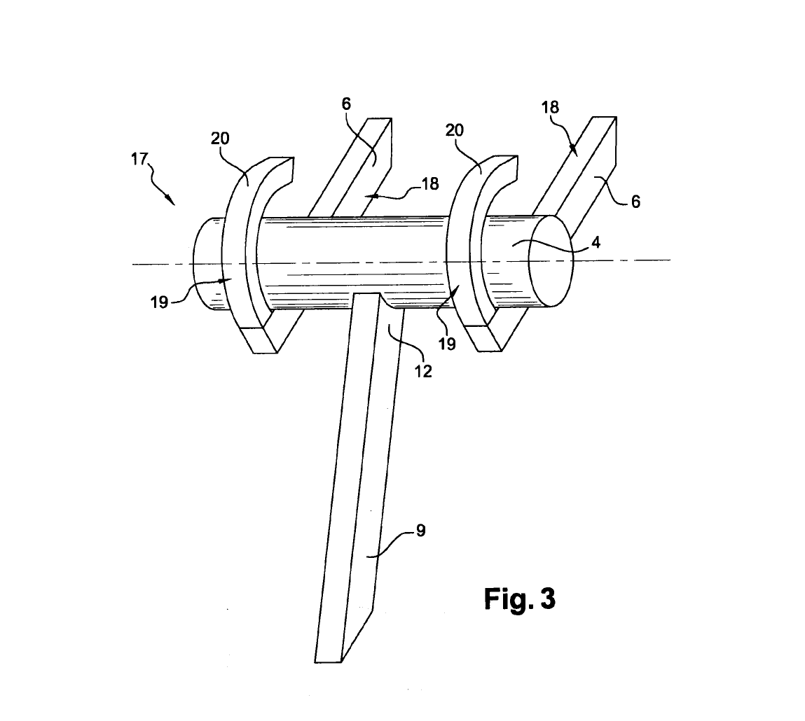

A detailed description of one preferred embodiment of a pedal mounting device according to the invention is given hereinafter with reference to FIGS. 1 and 3.

FIG. 1 is a schematic view of a mounting device according to the invention simultaneously showing a normal first position of the pedal and a modified second position thereof.

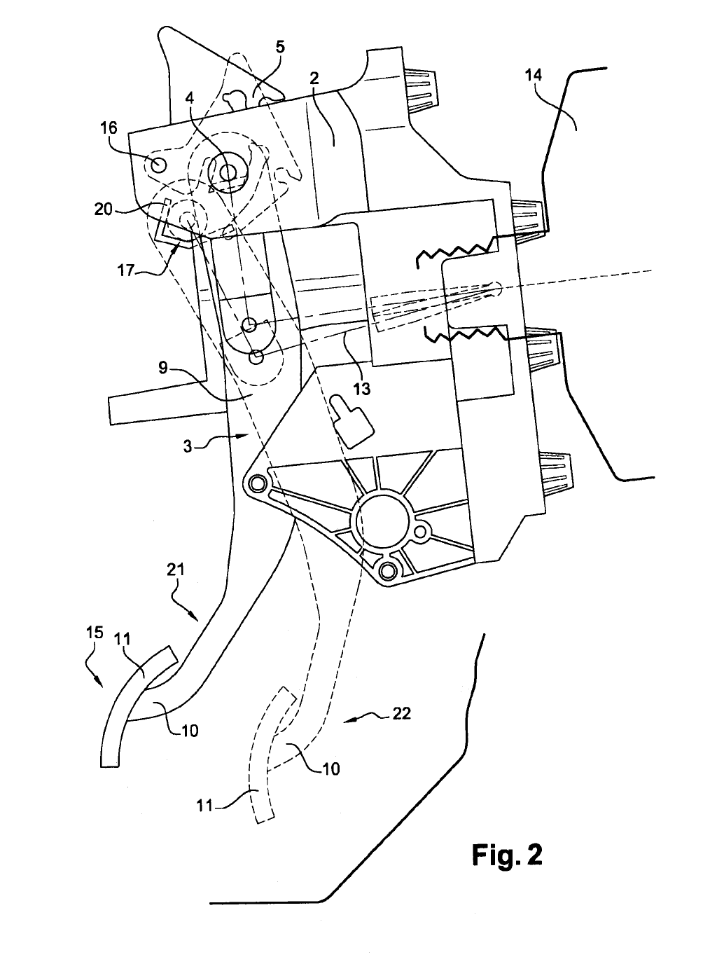

FIG. 2 is a fuller view of FIG. 1, notably showing the pedal mount.

FIG. 3 is a simplified perspective view of the pedal pivot pin catching means used in a device according to the invention.

With reference to FIG. 1 and FIG. 2, a pedal mounting device according to the invention comprises a mount 2 on which a brake pedal 3 is mounted via a pivot pin 4 and shearing means 5 secured to a fixed bodywork element. The shearing means 5, which may for example be similar to those described in Patent EP0965506, comprise two cutters 7 each consisting of two cutting branches 8 arranged in a V shape. The pedal 3 is made up in a conventional way of an elongate lever arm 9 a first end 10 of which ends in a rough pad 11, embodying the bearing surface on which a driver will apply pressure with his foot in order to initiate the braking of the vehicle, and a second end 12 of which bears the pivot pin 4 and is secured to the mount 2 by said pivot pin 4. Transmission elements 13 connect the lever arm 9 to the braking system 14. In normal operation, pressure applied to the pedal 3 at the pad 11 causes the pedal 3 to rotate about its pivot pin 4 in the direction indicated by the arrow 15, this rotation activating the transmission elements 13 which immediately initiate the braking of the vehicle. A return system then allows the brake pedal 3 to return to its initial position when the driver ceases to exert pressure to the pad 11. The shearing means 5 have been developed with a view to increasing driver safety in the event of a frontal impact. This is because in this type of impact, the mount 2 for the pedal 3 has a tendency to be pushed back toward the rear of the vehicle, taking with it the pivot pin 4 of the pedal 3 which is secured to it. The two cutting branches 8 of each cutter 7 positioned at each end of the pivot pin 4 then begin to pivot about a secondary axis 16 brought about by the rearward movement of the mount 2, so that the pivot pin 4 of the pedal 3 falls between said cutting branches 8 as it is pushed against these. This pivot pin 4 is ultimately sheared at its two ends under the effect of the two cutters 7, freeing the pedal 3 from its mount 2. The pedal 3 thus finds itself separated from any structure and can therefore no longer rigidly strike the driver's legs. The main technical feature of a device for mounting a pedal 3 according to the invention is that it comprises means 17 for catching the pivot pin 4 of the pedal 3 once this pivot pin has been cut through by the shearing means 5. It is naturally assumed that the pivot pin 4 of the pedal 3 is never separated from this pedal. Specifically, when the shearing means 5 come into action, they shear through the pivot pin 4 of the pedal 3, detaching the latter from its mount 2. The pedal 3 can then move autonomously and uncontrollably in the passenger compartment. The catching means 17 catch the pedal 3 thus freed, at its pivot pin 4, to trap it in a second operational position.

With reference to FIG. 3, the catching means 17 comprise guide means 18 and two stop pieces 19. The guide means 18 consist of two parallel rails 6 the separation of which is designed, on the one hand, to support the pivot pin 4 of the pedal 3 once it has been sheared by the shearing means 5 and, on the other hand, to allow the lever arm 9 of the pedal 3 to pass between them. Each of the two rails 6 ends in a curved end 20, which with the corresponding rail 6 forms an elbow at approximately 180°. The radius of curvature of this elbow is greater than the radius of curvature of the pedal pivot pin 4 so that said pivot pin 4 can slide along the two rails 6 and come to rest against the two curved ends 20 that form stop pieces 19. In order to convey the pivot pin 4 of the pedal 3 against the stop pieces 19, the rails 6 are at a slight slope.

Referring to FIGS. 1 and 2, the catching means 17 are positioned under the pivot pin 4 of the pedal 3 when the latter is in its normal operating position. Thus, if its pivot pin 4 is broken by the shearing means 5, the freed pedal 2 will have a tendency to drop toward the floor of the vehicle under the effect of its self weight. The pin will therefore naturally become lodged on the guide rails 6. When all these components are installed in a vehicle, the pivot pin 4 of the pedal 2 runs in a transverse direction of the vehicle and the two rails 6 are parallel to a longitudinal axis of said vehicle. The means 17 for catching the pivot pin 4 of the pedal 3 are designed to act when said pivot pin 4 has been cut through by the shearing means 5, either following an accidental frontal impact or without provocation under normal driving conditions.

The mounting device according to the invention allows the brake pedal 3 to react in the following steps. Once its pivot pin 4 has been chopped through under the effect of the shearing cutters 7, the pedal 3 detached from its mount 2 begins to fall toward the floor of the vehicle under the effect of its self weight. The pivot pin 4 naturally positions itself on the two slightly sloping rails 6 then slides along these until it comes into abutment against their bent up ends 20. The pedal 3 has thus moved downward slightly, causing its lever arm 9 to pivot in a direction for which the angle of rotation which the pedal 3 has to undergo in order to brake the vehicle is smaller by comparison with the angle of rotation it would have had to undergo in normal operation. In this way, the brake pedal moves from a fully operational first position 21 into an operational second position 22, which is not quite as operational because of the smaller actuating travel. In the first configuration 21, the pedal 3 can be actuated with a wide range of movement so that it fully performs its braking function. In the second configuration 22 it can still be actuated in order to perform the braking function, but with slightly less effectiveness.

1-10. (canceled)

11. A device for mounting a vehicle pedal, comprising:
a mount on which the pedal is mounted via a pivot pin;
shearing means connected to a fixed bodywork element of the vehicle, the shearing means configured to shear the pivot pin radially if the mount moves in relation to the bodywork element, to detach the pedal from the mount;
catching means positioned near to the pivot pin of the pedal in its normal position and configured to catch the pivot pin once it has been sheared to allow the pedal to occupy a second position close to the position it usually occupies, the second position still allowing the pedal to be actuated so that the pedal can at least partially perform its initial function.

12. The device as claimed in claim 11, wherein the pedal is a brake pedal and the vehicle is a motor vehicle.

13. The device as claimed in claim 11, wherein the catching means comprises guide means and at least one stop piece for stopping the pivot pin.

14. The device as claimed in claim 13, wherein the guide means comprises two rails which are parallel and at a slight slope, and each of the two rails ends in a curved end, the ends each constituting a stop piece for stopping the pivot pin.

15. The device as claimed in claim 14, wherein each end forms an elbow rounded at 180°, a radius of curvature of the elbow being greater than a radius of curvature of the pivot pin.

16. The device as claimed in claim 14, wherein separation of the rails is great enough to allow the pedal to rotate once the pivot pin is resting against each of the stop pieces that stop it.

17. The device as claimed in claim 11, wherein the shearing means comprises at least one cutter.

18. The device as claimed in claim 17, wherein each cutter comprises two cutting branches in a form of a V.

19. The device as claimed in claim 11, wherein the catching means is placed below the pivot pin of the pedal in normal operation, allowing the pivot pin to become lodged through inertia in the catching means once the pedal has been detached from its mount.

20. The device as claimed in claim 11, wherein the second position adopted by the pedal after it has been detached from its mount allows the pedal still to be actuated, but with a reduced travel.
